(19) United States
(12) Patent Application Publication
(10) Pub. No.: US 2026/0149717 A1
(43) Pub. Date: May 28, 2026

(54) PROCESS CONTROL SYSTEMS USING ACTIVE DIRECTORY TO MANAGE USER ACCESS OF FIELD DEVICES

(71) Applicant: Bristol, Inc., d/b/a Remote Automation Solutions, Houston, TX (US)

(72) Inventors: Mahesh Gade, Marshalltown, IA (US); Leo Kapsner, Albertville, MN (US)

(21) Appl. No.: 18/961,034

(22) Filed: Nov. 26, 2024

(51) Int. Cl. H04L 9/40

(52) U.S. Cl. CPC H04L 63/102; H04L 63/104; H04L 63/107

(57) ABSTRACT

Process control systems using active directory to manage user access of field devices are disclosed herein. An example process control system includes a user management system including an active directory of user names and group names assigned to respective ones of the user names, a computer to communicate with the user management system over a network, and a field device to communicate with the user management system and the computer over the network. The computer is to be operated by a user to connect to and access information on the field device. The user has a first user name. The field device is to determine a first permission configuration associated with a first group name assigned to the first user name, and establish a working session with the computer and allow access and communications between the field device and the computer based on the first permission configuration.

### FIELD OF THE DISCLOSURE

This disclosure relates generally to process control systems and, more particularly, to process control systems using active directory to manage user access of field devices.

### BACKGROUND

Process control systems, such as those used in chemical processing plants, factories, refineries, etc., include a large number of field devices such as sensors and valves. These field devices monitor certain parameters and/or control certain parameters of the system. These field devices often need to be checked and/or re-configured. Personnel often use a computer or other electronic device to connect to a field device to access and check data on the field device and/or make configuration changes to the field device.

### SUMMARY

An example process control system disclosed here includes a user management system including an active directory having user names and group names assigned to respective ones of the user names, a computer to communicate with the user management system over a network, and a field device to communicate with the user management system and the computer over the network. The computer is to be operated by a user to connect to and access information on the field device. The user has a first user name. The field device is to determine a first permission configuration associated with a first group name assigned to the first user name, and establish a working session with the computer and allow access and communications between the field device and the computer based on the first permission configuration.

An example user management system disclosed herein includes an active directory having user names and group names assigned to respective ones of the user names, machine readable instructions, and programmable circuitry to at least one of instantiate or execute the machine readable instructions to: validate a user name and a password received from a computer, wherein the computer is operated by a user to connect to a field device, access the active directory to determine a group name assigned to the user name, and transmit the group name to the computer, wherein the group name is to enable the field device to determine a permission configuration associated with the group name.

An example non-transitory machine readable storage medium comprises instructions to cause programmable circuitry to at least: validate a user name and a password received from a computer, wherein the computer is operated by a user to connect to a field device, access an active directory to determine a group name assigned to the user name, the active directory having a plurality of user names and group names assigned to respective ones of the user names, and transmit the group name to the computer, wherein the group name is to enable the field device to determine a permission configuration associated with the group name.

An example computer disclosed herein includes communication circuitry, a user interface, machine readable instructions, and programmable circuitry to at least one of instantiate or execute the machine readable instructions to: transmit a user name and a password of a user to a user management system having an active directory of user names and group names assigned to respective ones of the user names, receive a group name assigned to the user name from the user management system, transmit the group name to a field device, and create a working session with the field device and display data from the field device based on a permission configuration in the field device associated with the group name.

An example non-transitory machine readable storage medium comprises instructions to cause programmable circuitry to at least: transmit a user name and a password of a user to a user management system having an active directory of user names and group names assigned to respective ones of the user names, receive a group name assigned to the user name from the user management system, transmit the group name to a field device, and create a working session with the field device and display data from the field device based on a permission configuration in the field device associated with the group name.

An example field device disclosed herein includes communication circuitry, memory with group permissions, machine readable instructions, and programmable circuitry to at least one of instantiate or execute the machine readable instructions to: receive communication from a computer and authenticate the computer using a secure protocol, receive a user name and a group name from the computer, access the group permissions to determine a permission configuration based on the group name, and communicate with the computer based on the permission configuration.

An example non-transitory machine readable storage medium comprises instructions to cause programmable circuitry to at least: receive communication from a computer and authenticate the computer using a secure protocol, receive a user name and a group name from the computer, access group permissions to determine a permission configuration based on the group name, and communicate with the computer based on the permission configuration.

### BRIEF DESCRIPTION OF THE DRAWINGS

FIG. 1 is a block diagram of an example process control system including example field devices, an example computer, and example user management system.

FIG. 2 is a block diagram of an example implementation of the example user management system of FIG. 1.

FIG. 3 is a block diagram of an example implementation of the example computer of FIG. 1.

FIG. 4 is a block diagram of an example implementation of one of the example field devices of FIG. 1.

FIG. 5 illustrates an example active directory implemented in the example user management system of FIG. 2.

FIG. 6 illustrates an example device-based configuration of the example active directory of FIG. 5.

FIG. 7 illustrates an example location-based configuration of the example active directory of FIG. 5.

FIG. 8 illustrates example security keys for the example field devices as stored in an example credential manager of the example user management system of FIG. 2

FIG. 9 illustrates example limited use passwords as stored in a limited use password manager of the example user management system of FIG. 2.

FIG. 10 illustrates an example log in screen on the example computer of FIG. 3.

FIG. 11 illustrates an example interface on the example computer of FIG. 3 for interacting with the example field devices.

FIG. 12 illustrates example permission configuration stored in the example field device of FIG. 4.

FIG. 13 is a flowchart representative of example machine readable instructions and/or example operations that may be executed, instantiated, and/or performed by example programmable circuitry to implement the example user management system of FIG. 2.

FIG. 14 is a flowchart representative of example machine readable instructions and/or example operations that may be executed, instantiated, and/or performed by example programmable circuitry to implement the example computer of FIG. 3.

FIG. 15 is a flowchart representative of example machine readable instructions and/or example operations that may be executed, instantiated, and/or performed by example programmable circuitry to implement the example field device of FIG. 4.

FIG. 16 is a block diagram of an example processing platform including programmable circuitry structured to execute, instantiate, and/or perform the example machine readable instructions and/or perform the example operations of FIG. 13 to implement the example user management system of FIG. 2, the example operations of FIG. 14 to implement the example computer of FIG. 3, and/or the example operations of FIG. 15 to implement the example field device of FIG. 4.

FIG. 17 is a block diagram of an example implementation of the programmable circuitry of FIG. 16.

FIG. 18 is a block diagram of another example implementation of the programmable circuitry of FIG. 16.

FIG. 19 is a block diagram of an example software/firmware/instructions distribution platform (e.g., one or more servers) to distribute software, instructions, and/or firmware (e.g., corresponding to the example machine readable instructions of FIGS. 13-15 to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Process control systems are used in many industries, such as chemical, power, water and waste, paper and pulp, and oil refineries, and typically include a large number of field devices that are used to monitor and/or control various parameters of the process control system. Field devices include devices such as controllers, valves, valve positioners, switches, sensors, etc. These devices can be used to measure and/or monitor certain parameters, such as temperature, pressure, flow rater, etc., and/or can be used to control certain parameters, such as pressure, flow rate, etc. Large process control systems can include hundreds or thousands (or more) of field devices.

Personnel (e.g., engineers, operators, auditors, etc.) at the process control system often need to access the field devices to obtain measurements, check configurations, make changes (e.g., open a valve), etc. A user may access a field device by connecting their computer (e.g., laptop) to the field device using a configuration, diagnostic and monitoring application. The connection between the computer and the field device may be wired or wireless. Each field device stores user account information including login credentials and permission settings for each user. In particular, different types of users may be able to access and/or change different information on the field device. For example, an engineer may be able to read device files, perform calibration tests, and update firmware, whereas an auditor may only be able to read device files but cannot perform any tests or update firmware. If a user's role changes, his/her permissions need to be updated in every field device. Further, if a new user is to be added, or an existing user needs to be removed, these changes need to be updated in the user account information on every field device. Some process control systems contain a significantly large (e.g., 1,000+) number of field devices. As such, this process of updating user account information and permissions on every field device is extremely cumbersome and complex.

Disclosed herein are example systems and methods that utilize an active directory architecture to manage user access to field devices in a process control system. The active directory can be maintained in a centralized active directory server (e.g., at the facility or cloud-based). The active directory stores user names for all of the users and an assigned group name for each of the user names. When a user connects to a field device with a computer, the user's login credentials are transmitted to the active directory server and validated. Then, the active directory obtains the group name associated with the user name and sends the group name to the computer, which is then transmitted to the field device. Each field device contains a set of permissions or permission configuration for each group. For example, if the user is an engineer, engineers are granted permission to perform calibration tests, updated firmware, etc., whereas if the user is an auditor, auditors may only be able to read device files. Each field device can have different permission configurations for the various groups. As such, the permissions granted to a user are based on the user's assigned group as managed in the active directory. If there are any changes to a user's group, this information can be easily updated in the active directory. Further, if new users need to be added or existing users need to be removed, these changes can be made in the active directory. The field devices no longer need to store user account information (user names and passwords) and specific privileges for each user. As such, any time there is a change to user accounts and/or their roles, the field devices do not need to be updated, as was required in known system architectures. This significantly reduces memory and computing power requirements at the field devices.

The example systems and methods disclosed herein also manage distribution of certificates and keys from a central location, which offers more flexibility. Further, the example systems and method disclosed herein enable the use of a limited (e.g., one-time) use password to connect to a field device if the active directory is offline.

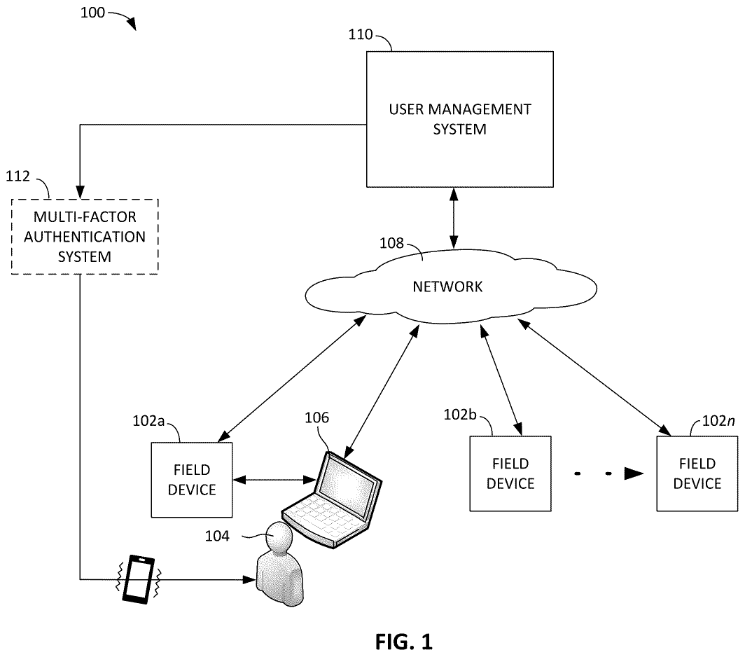

FIG. 1 illustrates an example process control system 100 constructed in accordance with the teachings disclosed herein. The process control system 100 can correspond to any process control system that utilizes one or more field devices. For example, the process control system 100 can be a facility such as a power plant, a factory (e.g., a paper mill), or a refinery (e.g., hydrocarbon, gasoline, etc.).

The process control system 100 includes a plurality of field devices 102a-102n, which can also be referred to as process control devices or process automation devices. The field devices 102a-102n can be distributed throughout the facility and used to monitor (e.g., measure, detect) various parameters of the system and/or control various parameters of the system. The field device 102a-102n can include, for example, a flow computer, a remote terminal unit (RTU), a finite control element, and/or an end device. For example, a field device can include a sensor such as flow rate sensor, a temperature sensor, a pressure sensor, etc. used to measure a parameter of the process control system 100. As another example, a field device can include a controllable or automated device such as a digital valve controller (DVC), a motor-operated valve (MOV), an air-operated valve (AOV), a digital controller, a programmable logic controller (DLC), etc.

Personnel, referred to herein as users, routinely need to access the field devices 102a-102n and check various data (e.g., sensor outputs), run calibration tests, and/or make changes to various device configurations. These users can be, for example, engineers, auditors, contractors, etc. An example user 104 is illustrated in FIG. 1. In the illustrated example, the process control system 100 includes a computer 106 that the user 104 can use to access a field device, such as the first field device 102a. In some examples, the computer 106 is a laptop computer, but in other examples can be implemented by another type of computer or electronic device such as a desktop computer, a tablet, or a phone. The user 104 may connect the computer 106 to the field device 102 directly using a physical connection, such as via an Ethernet connection or a Universal Serial Bus (USB) connection. Additionally or alternatively, the computer 106 can connect to the first field device 102a over a network 108 established at the facility. The network 108 can be any wired and/or wireless network between the various devices. For example, the network 108 can be a hardline connection such as Ethernet, and/or can include wireless connection between devices such as cellular, Bluetooth®, WirelessHART, etc. The network 108 is typically protected via a firewall from the outside. The computer 106 includes software, such as a configuration, diagnostic and monitoring application, used to communicate with the field devices 102a-102n using a secure communication protocol, such as Device Network Protocol (DNP3) with SAV5. The user 104 can use the application on the computer 106 to view device information and/or make changes to a field device. It is understood that the example process control system 100 can include any number of field devices 102a-102n. Further, while one example computer 106 is shown, the process control system 100 can include any number of computers for any number of users for accessing the various field devices 102a-102n.

In the illustrated example, the process control system 100 includes a user management system 110. In some examples, one or more components of the user management system 110 can be located on site, such as in a control center/room of the facility, for example. In other examples, one or more components of the user management system 110 may be cloud-based. The user management system 110, the computer 106, and the field devices 102a-102n can communicate over the network 108. When the user desires to connect to and access information on the first field device 102a, for example, the user 104 enters his/her login information into the software program on the computer 106, which then transmits the user credentials to the user management system 110. The user management system 110 checks the user's credentials against a database of active user accounts. If the user 104 does not have an active account, permission is denied. If the user 104 has an active account and the user credentials are authorized, the user management system 110 obtains an assigned group or role of the user 104, which may be identified by group names. In particular, the user management system 110 maintains an active directory of all user accounts and assigned group names, as disclosed in further detail herein. For example, the group names may include, for example, Engineer, Measurement Tech., Auditor, Operator, and Admin. In some examples, the active directory is configured to maintain default group names (e.g., Engineer, Measurement Tech, etc.) and/or can be configured to have custom group names (e.g., Custom Group-1, Custom Group-2, etc.). The user management system 110 transmits the user's assigned group name back to the computer 106, which transmits the group name to the first field device 102a. Based on the group name, the first field device 102a allows the user 104 to access certain information and/or modify certain settings based on the permissions for that type of group. For instance, the first field device 102a may allow different privileges for Engineers and Auditors. For example, an Engineer may be able to read device files (e.g., sensor outputs), perform calibration tests, update firmware, etc., while an Auditor may only be able to read device files.

The example system 100 is advantageous because if a user's role is changed (e.g., from Auditor to Engineer) in the company, the user's assigned group name can be easily updated in the active directory of the user management system 110. Therefore, whenever a field device checks the user's group name, the most recent group name is obtained and relayed to the field device. As such, individual user accounts and their permissions do not need to be stored and managed on each field device 102a-102n or on the computer 106. This significantly reduces memory and computing resource power needed on each field device 102a-102n, as well as establishes a more efficient manner for managing various user accounts and their roles/groups.

In some examples, as shown in FIG. 1, the process control system includes and/or otherwise uses a multi-factor authentication system 112 (e.g., DUO®, Google®, Microsoft®, etc.) to validate or authenticate users when signing into the system or application on the computer 106. The multi-factor authentication system 112 may communicate with an authenticator application on the user's cellphone, for example. However, in other examples, multi-factor authentication may not be used.

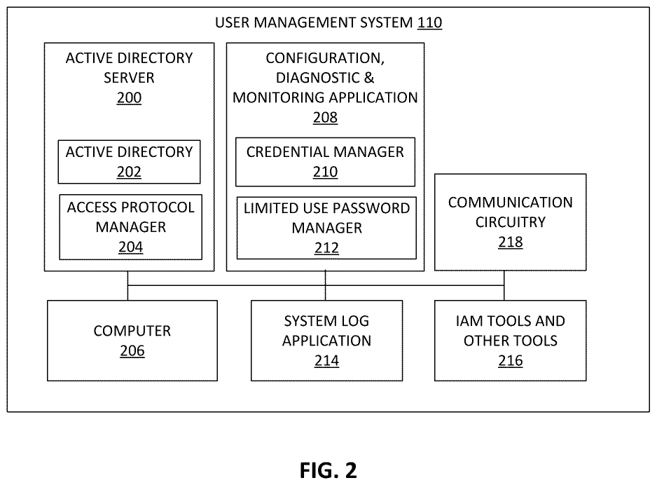

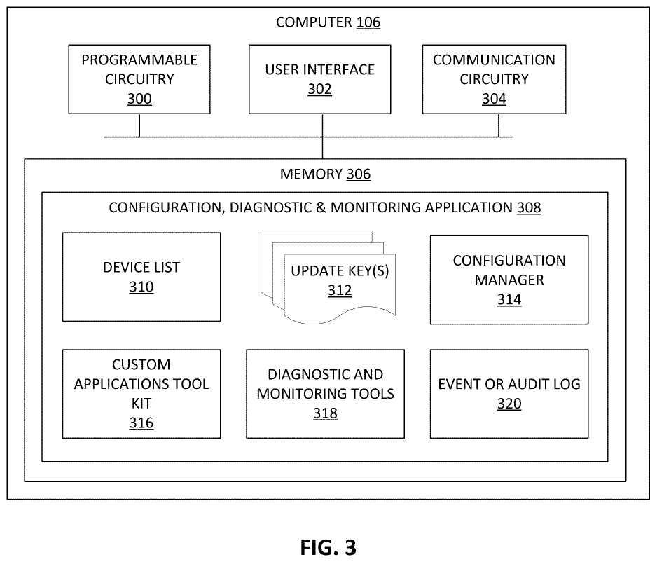

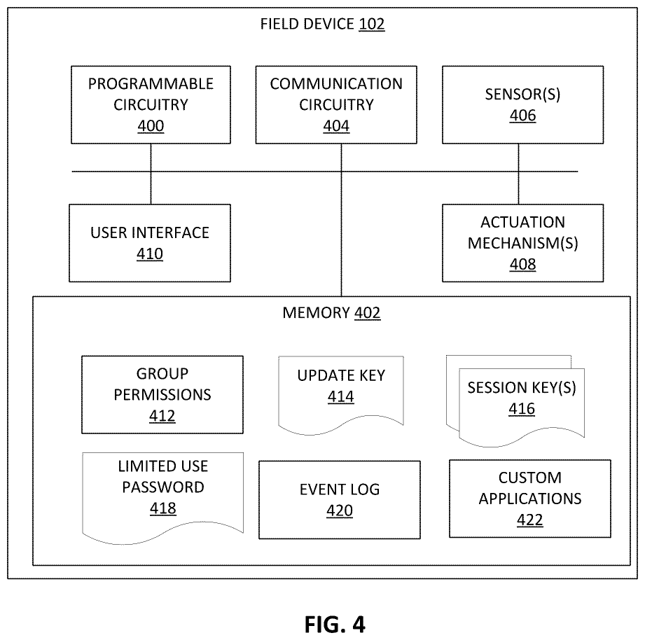

FIG. 2 is a block diagram of the example user management system 110, FIG. 3 is a block diagram of the example computer 106, and FIG. 4 is a block diagram of an example one of the field devices 102.

Referring first to FIG. 2, the user management system 110 includes an active directory server 200. The active directory server 200 includes an active directory 202 of active user accounts and their associated group names (e.g., role names). The active directory server 200 also includes an access protocol manager 204 that manages a secure protocol for access and communication between users and the active directory server 200. The secure protocol can include Lightweight Directory Access Protocol (LDAP), LDAP encrypted using TLS/SSL as a wrapper (referred to as LDAPS), or RADIUS server, for example.

In the illustrated example, the user management system 110 includes a computer 206, which can be used to access and configure the active directory server 200. The computer 206 may be, for example, an admin or IT computer used by an admin of the facility for managing (e.g., setting up, configuring, maintaining, etc.) the active directory 202. The computer 206 can include any user interface components (e.g., a keyboard, a display, etc.) to interact with the active directory server 200 and the access protocol manager 204. The computer 206 can be any type of computing device, and could be part of or remote to the active directory server 200. The computer 206 can be a computer with or without server virtualization (e.g., a Citrix server virtualization). For example, the computer 206 may have software that can directly connects to the active directory server 200. However, in other examples, the computer 206 can be a thin client with a virtualization link to connect the computer 206 to a remote server where the software and user instance is run.

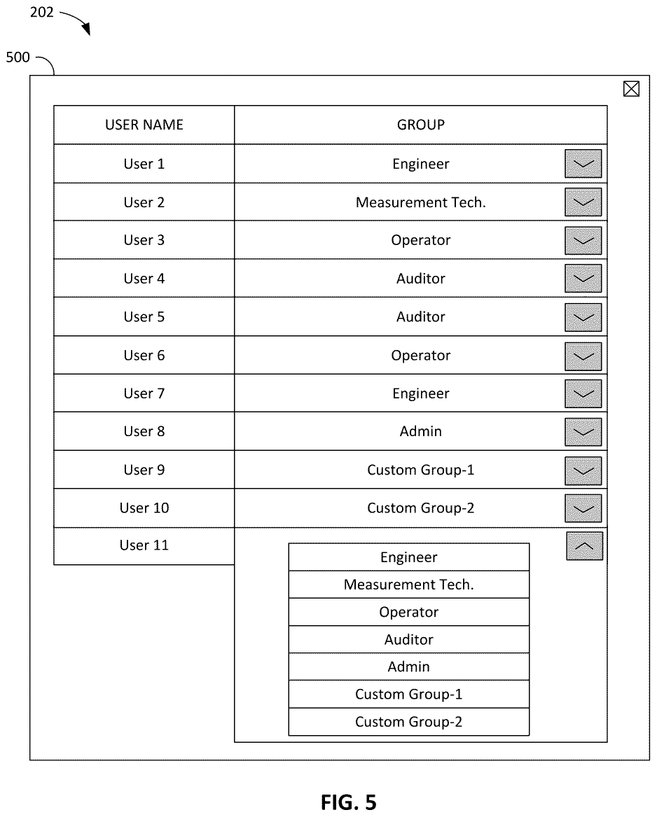

FIG. 5 shows an example of the active directory 202. The active directory 202 can be displayed in a window 500 on the computer 206, for example. The active directory 202 includes a list of all the active user names (also referred to as user IDs) and the group names assigned to respective ones of the user names. In this example, the group names are based on possible job roles or responsibilities within a facility. For example, as shown in FIG. 5, User 1 is assigned to the Engineer group, User 2 is assigned to the Measurement Tech. group, and so forth. In some examples, a user, such as an admin, can manually assign the appropriate group name to the corresponding user name. For example, if a new employee is hired, the employee is assigned a user name and a group name is assigned to the user name and stored in the active directory 202. Further, the user's assigned group name can be changed if the user changes roles (e.g., changes from an Engineer to a Measurement Tech.). In some examples, there are five possible group names, 1) Engineer, 2) Measurement Tech., 3) Operator, and 4) Auditor, and 5) Admin. In some examples, the group name can be selected from a dropdown menu, such as shown in connection with User 11, but can be assigned in other manners too. In other examples, the number of possible group names may be larger or smaller and/or have different group names. In some examples, the active directory 202 has a default listing of possible groups, such as the five groups shown in FIG. 5. In some examples, custom group names can be created (e.g., an admin or IT personnel can create a custom group name via the computer 206 interacting with the active directory 202). For example, as shown in FIG. 5, the available group names include Custom Group-1 and Custom Group-2. Any time new group names are created or removed, these available group names are updated in the field devices 102a-102n via a secure communication between the user management system 110 and the field devices 102a-102n. Custom group names can be used to define more granular privileges. In some examples, the active directory 202 may include a large number of group names. In such examples, prefix group names with custom labels can be used.

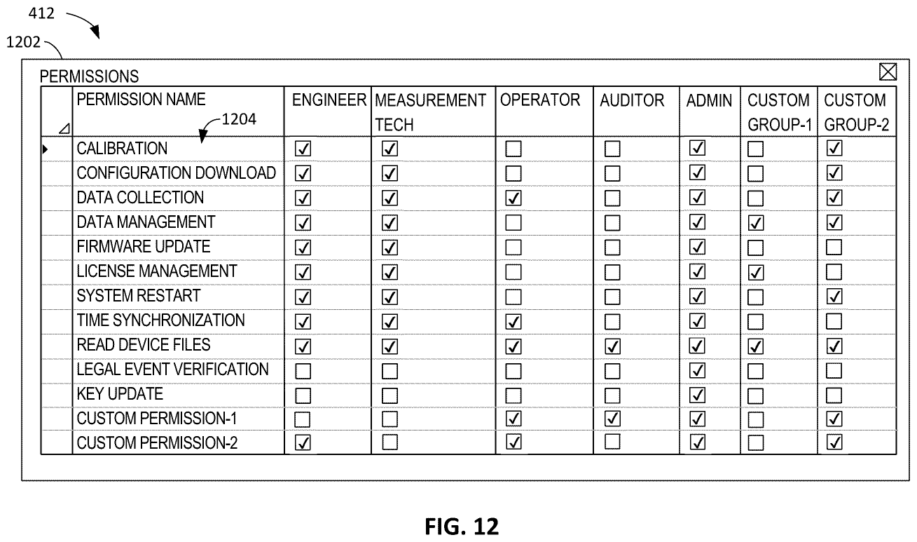

The assigned group names are used by the field devices 102a-102n to determine what permissions the user 106 has when accessing the respective field devices 102a-102n. For example, when the user 104 desires to access a field device, the computer 106 sends the user's user name to the active directory server 200. The active directory server 200 obtains the user's group name from the active directory 202 and sends the group name back to the computer 106. The computer 106 sends the group name to the field device via a secure protocol (disclosed in further detail herein). Based on the group name, the field device determines which permissions or privileges the user has. Each group may have a different set of permissions stored within the field device. For example, referring briefly to FIG. 12, FIG. 12 shows an example group permissions 412 as stored in the field device 102. The group permissions 412 can be displayed in a window 1202 on a computer, such as the computer 206, for example. The group permissions 1200 includes a plurality of permissions 1204, such as Calibration, Configuration Download, Data collection, and so forth. As shown, each group (Engineer, Measurement Tech, Operator, Auditor, Admin, Custom Group-1, Custom Group-2) has a different set or configuration of the permissions 1204. Therefore, depending on the user's assigned group name, the user 104 may have different permissions or capabilities when interacting with the field device. For example, if the user 104 is identified as an Engineer, the user 104 may be able to update firmware, read device files, etc., whereas if the user 104 is identified as Auditor, the user can only read device files but not update firmware. Each field device 102a-102n may have a different configuration of permissions for each of the groups. For example, the first field device 102a may allow an Engineer to perform calibration, but the second field device 102b may not allow an Engineer to perform calibration. In this example, the permissions are assigned by checking boxes in the window 1202. In some examples, one or more of the group may have all permissions or privileges. For example, as shown in FIG. 12, the Admin group is granted all permissions or privileges. In some examples, all of the field devices 102a-102n have the same set of default permissions 1204 that can be assigned to each group. In some examples, the field devices 102a-102n can be configured to have customized permissions. For example, the permissions 1204 include Custom Permission-1 and Custom Permission-2, which may be created by an admin or IT personnel. Therefore, the listing of permissions 1204 can be longer or shorter and/or contain different types of permissions. The amount and type of permissions provides for more granularity of the privileges granted to a user.

The example process control system 100 is advantageous because the individual field devices 102a-102n do not need to store all of the individual user accounts and associated permissions for each user account, which can routinely change. Instead, the active directory 202 is used to manage the groups for all of the user accounts, and the individual field devices 102a-102n only need the group name to determine the correct permission configuration for that user. Therefore, any changes to the user accounts and/or their assigned roles do not need to be continuously updated in each of the field devices 102a-102n, as was done in the past.

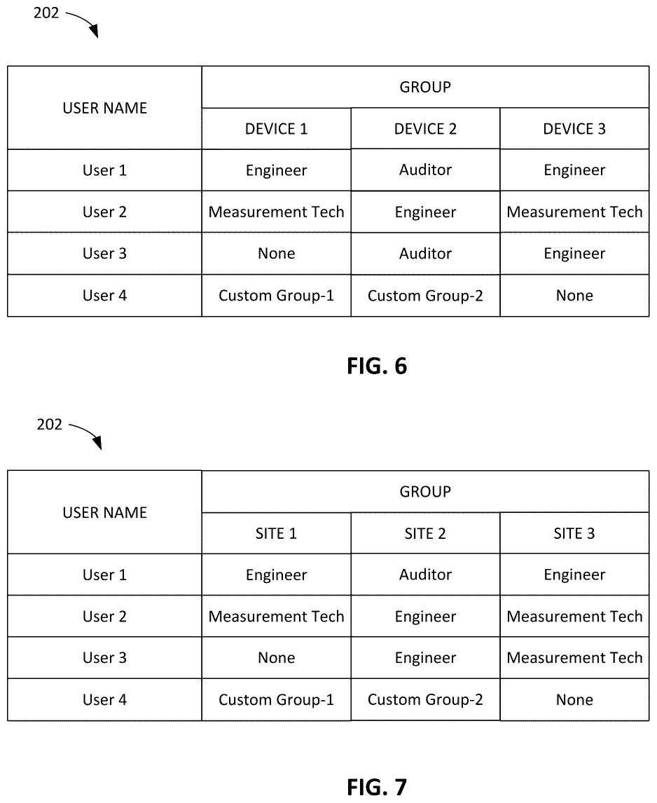

In some examples, the active directory 202 can be configured to have different group names assigned to respective ones of the user names for each of a plurality of field devices. For example, FIG. 6 shows an example of the active directory 202 in which each user name can have a different assigned group name for three different devices. For example, User 1 is assigned as an Engineer for Device 1, but assigned as an Auditor for Device 2. Therefore, if User 1 is accessing Device 1, the active directory server 200 returns the Engineer group name to the computer 106, whereas if User 1 is accessing Device 2, the active directory server 200 would return the Auditor group name to the computer 106. Users can also be assigned to the custom group names (e.g., Custom Group-1, Customer Group-2, etc.) for each of the devices. This ability to assign each user to different groups for each device enables an admin to control which permissions or privileges the users have at the different field devices 102a-102n. In some examples, a user may not have access to certain ones of the field devices. For example, as shown in FIG. 6, User 3 does not have access to Device 1 (assigned to group None), but does have access to Devices 2 and 3. This restricted access can be stored in the active directory 202.

Additionally or alternatively, the active directory 202 can be configured to have different group names assigned to respective ones of the user names for each of a plurality of locations. For example, a company may have multiples sites in different locations or areas. Each location represents a grouping of field devices in that location. As shown in FIG. 7, different group names can be assigned to the user names based on the different sites. In some examples, the sites may be different locations within the same facility. For example, the facility may be divided into a north side and a south side, and different group names can be assigned based on whether the device is in the north side or the south side. For example, a user accessing a field device on the north side of the facility may be assigned to the Engineer group, but when accessing a field device on the south side may be assigned to the Auditor group and, thus, the permissions on each device may be different. In some examples, a user may not have access to certain ones of the sites. For example, as shown in FIG. 7, User 3 does not have access to Site 1 (assigned to group None), but does have access to Sites 2 and 3.

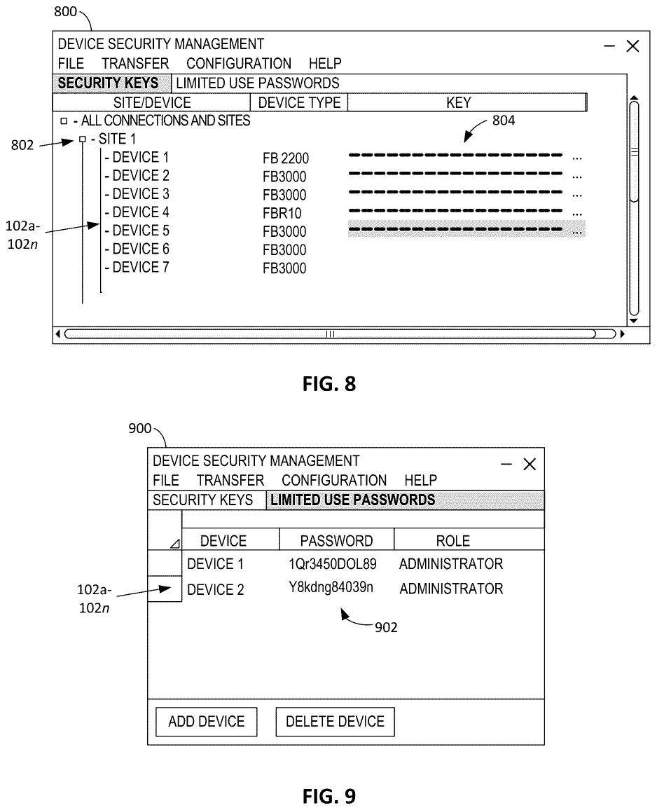

Referring back to FIG. 2, the user management system 110 includes a configuration, diagnostic and monitoring application (CDMA) 208. The CDMA 208 may be, for example, Field Tools, which is a software application provided by Emerson® and used for connecting with field devices, interacting with field devices, and displaying field device data and information. The CDMA 208 includes a credential manager 210 that stores and manages the security keys or certificates used to connect to the various field devices 102a-102n. Each field device 102a-102n has a specific key. In some examples, the keys are SAV5 keys. In other examples, other types of security protocol keys can be used. For example, FIG. 8 shows an example window 800 displaying a list of the field devices 102a-102n at a particular site 802 and the keys 804 associated with the field devices 102a-102n. The site name and field device names can be customized. The credential manager 210 distributes these keys 804 to the respective field devices 102a-102n. The credential manger 210 also distributes certain ones of the keys 804 to the computer 106 so that the computer 106 can securely connect to certain ones of the field devices 102a-102n. For example, if the computer 206 is connecting to only one field device, the credential manager 210 may only send the key 804 for that field device. In other examples, if the computer 206 is connecting to multiple field devices, such as all of the field devices in Site 1, the credential manager 210 would send the respective keys 804 for those field devices in Site 1. The keys 804 can be pushed to the devices periodically (e.g., one a week, once a month, etc.). In some examples, if a RADIUS server such as Microsoft® NPS is used, the user group names can be communicated using the custom attributes features, via secure communication between the RADIUS server and the CDMA 208 using certificates.

The CDMA 208 also includes a limited use password manager 212. The limited use password manager 212 stores and manages limited use passwords (e.g., one-time use passwords) that can be used to access the various field devices 102a-102n in the event of no connection to the active directory server 200. FIG. 9 shows an example window 900 displaying limited use passwords 902 for the field devices 102a-102n. The limited use passwords 902 are distributed (e.g., via a secured communication-line interface (CLI) such as CyberArk) to the respective field devices 102a-102n. If a user's computer 106 cannot connect to the active directory server 200, for example, the user 104 can call the admin or IT personnel and ask for the limited use password 902 for a specific field device, which can be used to connect the computer 106 to that device. The limited use password 902 is checked against the limited use password stored on the field device and, if it matches, the user 104 is granted access to the field device. The limited user passwords 902 can be limited to a number of uses, such as one time. As such, once a limited use password is used, it cannot be used again to access that field device. In other examples, the limited use passwords 902 can be limited by time (e.g., only valid for 30 minutes). In some examples, the limited use passwords 902 are distributed to the field devices 102a-102n at a predetermined frequency (e.g., once a week, once a month, etc.).

Referring back to FIG. 2, the user management system 110 includes a system log application 214. The system log application 214 receives event information from the field devices 102a-102n and logs/records all of the event information. For example, each time a user accesses a field device or makes a change to a field device, the field device sends the event to the system log application 214 where it is recorded. If a discrepancy or issue arises, the system log application 214 can be checked to determine what events occurred at or around the time of the discrepancy. In some examples, the system log application 214 can also record failed login attempts. In FIG. 2, the user management system 110 also includes Identify and Access management (IAM) security tools and/or other applications and tools 216. In some examples, the IAM security tool is Cyberark.

The user management system 110 includes communication circuitry 218, which can be used to communicate via any wired (e.g., Ethernet, USB, etc.) or wireless (e.g., cellular, radio, Bluetooth, etc.) techniques with the field devices 102a-102n and the computer 106. The communication circuitry 214 can be part of or integrated into any of the active directory server 200, the computer 206, the CDMA 208, the system log application 214, and/or the IAM tools and other tools 216. In other words, one or more of the above-noted components can have their own communication circuitry or can share common communication circuitry 218.

FIG. 3 is a block diagram of the computer 106. The computer 106 is used by the user 104 (FIG. 1) to connect to and interact with (e.g., view data, make changes, etc.) one or more of the field devices 102a-102n (FIG. 1). The computer 106 includes programmable circuitry 300, a user interface 302, communication circuitry 304, and memory 306. The programmable circuitry 300 can be implemented by one or more processors or microprocessors such as a Central Processor Unit (CPU), for example. The user interface 302 may include a display screen, a keyboard, a trackpad, and/or other user interface component(s), for example. The communication circuitry 304 can be implemented by any type of circuitry to communicate via a wired and/or wireless connection to the field devices 102a-102n and the user management system 110 (FIG. 1).

The computer 106 includes a configuration diagnostic and monitoring application (CDMA) 308, which may be stored as software instructions in the memory 306, and used to communicate with the user management system 110 (FIG. 1) and the field devices 102a-102n (FIG. 1). The CDMA 308 may be instantiated (e.g., creating an instance of, bring into being for any length of time, materialize, implement, etc.) by the programmable circuitry 300 executing the instructions. Additionally or alternatively, the CDMA 308 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

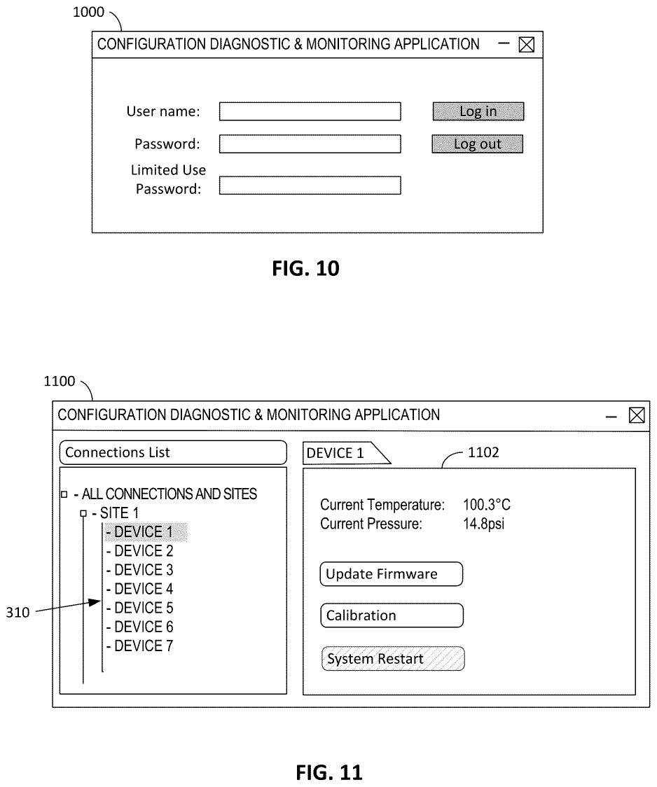

The user 104 (FIG. 1) may view and interact with the CDMA 308 on the user interface 302 (e.g., a display screen). In some examples, the user 104 first enters his/her user name and password to sign into the CDMA 208. For example, FIG. 10 shows an example login window 1000 in which the user 104 enters their user name and password. The CDMA 308 connects to and sends messages to and receives messages from the CDMA 208 (FIG. 1) in the user management system 110 (FIG. 1).

If the user name and password are valid, the CDMA 308 accesses a device list 310, which is a list of the field devices 102a-102n that the user 104 can access based on their user account. In some examples, the device list 310 is specific to the user. For example, if User 1 logs into the CDMA 308, one set of field devices may be available to access, but if User 2 logs into the application, a different set of field devices may be available to access. In some examples, a copy of the device list 310 is stored in the CDMA 308 on the computer 206. The copy of the device list 310 can be updated by the credential manager 210 (FIG. 2) of the CDMA 208 (FIG. 2) after logging in. In some examples, the credential manager 210 obtains the list of devices for the user 104 from the active directory 202 (FIG. 2). Therefore, one copy of the device list 310 may be stored in the active directory 202, and another copy may be stored in the CDMA 208, 308. In some examples, this is because the CDMA 208, 308 may need more metadata about a device to establish a connection, whereas the active directory 202 only needs to know whether the user has access or not to a device. In another example, the device list 310 can be built at runtime, and shown to the user 104 using the logged in user group names, and then shows only those devices that contain that group name.

FIG. 11 shows an example window 1100 of the CDMA 308 that can be displayed on the user interface 302. The window 1100 includes the device list 310 of the field devices 102a-102n. The user 104 (FIG. 1) can select to connect to one of the field devices 102a-102n. When the user 104 selects one of the field devices 102a-102n in the device list 310, the CDMA 308 sends the name of the device to the active directory server 200 (FIG. 1), which obtains the user's assigned group name and sends the group name back to the CDMA 308. The CDMA 308 connects to the selected field device using an update key 312 and sends the user name and group name to the selected field device. Once the computer 106 is connected to the selected field device, field device data and other options can be displayed in a window 1102, for example. For example, the user 104 has selected DEVICE 1. The window 1102 displays device information (e.g., sensor outputs) and other options available to interact with the DEVICE 1. Depending on the user's group name, the field device (DEVICE 1) grants the user 104 certain permissions or privileges. For example, the user 104 can view the temperature and pressure measurements, as well as perform firmware update and calibration operations. However, based on the user's group name, the user 104 is not permitted to perform a system restart.

Referring back to FIG. 3, the CDMA 308 receives and stores update keys 312 for the field devices 102a-102n (FIG. 1) in the device list 310. Each field device 102a-102n has a separate update key. The update keys 314 are used to establish a secure connection to the corresponding field devices 102a-102n. The update keys 312 are distributed by the credential manager 210 (FIG. 1). In some examples, the update keys 312 are SAV5 keys that enable DNP3 connection between the computer 106 and the field devices 102a-102n.

The CDMA 308 includes a configuration manager 314, which interacts with the connected field device and allows the user 104 (FIG. 1) to configure one parameter, multiple parameters, or all the parameters on the field device. The configuration manager 314 also performs operations such as firmware update, reading of diagnostic information, reading of history, events, and alarm logs, synchronization of device time, generation of reports including industry standard reports such as CFX and EFM, and Totalizer. In some examples, the CDMA 308 includes a custom applications tool kit 316, which enables the user 104 to develop their own custom application and custom screens to interact with. When the computer 106 is connected to a field device, the computer 106 publishes the custom application to the field device.

In the illustrated example, the CDMA 308 also includes diagnostic and monitoring tools 318, which is used to identify issues and perform health checks with a field device, perform prognostics, detect intrusions or invalid users from accessing a field device, monitor CPU utilization, monitor memory utilization, monitor high usual network traffic, and troubleshoot various issues that could occur with a field device. In the illustrated example, the CDMA 308 also includes an event or audit log 320, which is used to verify the changes that have been made by different users. The event or audit log 320 may store the user name of the user that made the change, the change that was made, and the time the change was made. In some examples, the event or audit log 320 can be used to diagnose if a user has made a change they should not have made, and/or can give a sequence of events in case an issue occurs.

FIG. 4 is a block diagram of an example field device 102, which can correspond to any of the field devices 102a-102n (FIG. 1). The field device 102 includes programmable circuitry 400, memory 402, and communication circuitry 404. The programmable circuitry 400 can be implemented by one or more processors or microprocessors such as a Central Processor Unit (CPU), for example. The communication circuitry 404 can be implemented by any type of circuitry to communicate via wired and/or wireless connection to the computer 106 (FIG. 1) and the user management system 110 (FIG. 1).

In some examples, depending on the type of field device, the field device 102 may include one or more sensors 406, such as a flow rate sensor, a temperature sensor, a pressure sensor, etc. For example, if the field device is a flow computer, the field device 102 may include one or more pressure sensors to monitor a differential pressure of a process fluid. Additionally or alternatively, depending on the type of field device, the field device 102 can include one or more actuation mechanism(s) 408, such as a motor, an actuator, a switch, etc. For example, if the field device 102 is a motor-operated valve (MOV), the field device 102 may include a motor (e.g., a DC electric motor) used for opening or closing the valve.

In some examples, the field device 102 includes a user interface 410, sometimes referred to as a local operator interface (LOI). The user interface 410 can include a display screen (e.g., LED screen), one or more buttons, a keyboard, etc. to enable a user to interact with and/or view certain data on the field device 102.

The memory 402 stores data and/or applications/software that can be executed by the programmable circuitry 400. In the illustrated example, the memory 402 stores the group permissions 412. The group permissions 412 includes a list of all of the groups and the their corresponding permissions. For example, FIG. 12 shows the example group permissions 412 as displayed in the window 1202. The group permissions 412 include each group name (in columns) and the available permissions 1204 in rows. Each group (Engineer, Measurement Tech, Operator, Auditor) has a different permission configuration of the available permissions 1204 (i.e., which actions are permitted and which are not). Therefore, depending on the user's assigned group, the user may have different permissions or capabilities when interacting with the field device 102.

Referring back to FIG. 4, the memory 402 stores an update key 414 that is used to establish a secure connection with another device, such as the computer 106 (FIG. 3). As disclosed above, the update key 414 is distributed by the credential manager 210 (FIG. 2). The update key 414 may be an SAV5 update key, for example. The computer 106 has a corresponding update key 312 for each field devices to which it may connect. The update key 414 on the field device 102 and the update key 312 on the computer 106 are used to create session keys 414, which are used to securely pass messages back-and-forth between the field device 102 and the computer 106 during a working session.

The memory 402 stores a limited use password 418 (sometimes referred to as a break glass password) that can be used to allow a user to access the field device 102 in an instance where the computer 106 (FIG. 3) cannot connect to the user management system 110 (FIG. 2), such as if the network 108 (FIG. 1) connection is unavailable. The field device 102 receives the limited use password 418 from the limited use password manager 212 (FIG. 2) of the user management system 110 and stores the limited use password 418 in the memory 402. The user management system 110 may periodically (e.g., once a day, once a week, once a month) send out a limited use password to each field device, which is then stored in the memory of the field device. In an example scenario, the user 104 is in a remote area and is trying to connect the computer 106 to the field device 102 but the computer 106 cannot connect to the user management system 110 because there is little or no wireless signal available. The user 104 may call the admin or IT personnel at the facility. The admin or IT personnel checks the limited use password (e.g., using the window 900 of FIG. 9) for that particular device as stored in the user management system 110 and conveys the password to the user 104 over the phone. In another scenario, the user 104 may obtain the limited use password for that device before traveling to the remote field location. When logging in, the user 104 enters their user name and the limited use password into the computer 106, such as shown in FIG. 10. The computer 106 sends the user name and the limited use password to the field device 102. The programmable circuitry 400 checks the limited use password against the most recent limited use password 418. If the password is still active, the computer 106 is granted permission to connect to the field device 102 and establish a working session for receiving and sending further data. However, if the limited used password is expired or not correct, the user 104 is not granted permission to connect to the field device 102. In some examples, the limited use password 418 is a one-time use password. As such, after the limited use password 418 is used once, the limited use password 418 is then deleted or registered as expired so that another user cannot subsequently connect another computer to the field device 102 with the same password. Therefore, the limited use password 418 allows a user access to the field device 102 in the event the computer 106 cannot make a connection to the user management system 110. Once the field device 102 establishes a connection with the user management system 110, a new limited use password is sent to the field device 102.

In some examples, the field device 102 firmware and the configuration diagnostic and monitoring application 208, 308 (FIG. 1) firmware are co-designed to prevent unauthorized modifications and/or hacking. In the example of FIG. 4, the memory 402 includes an event log 420 that stores all changes made by users, and cannot be deleted. The event log 420 may be used in the future if there is ever a discrepancy or issue with changed configurations or data. In some examples, the field device 102 firmware and the configuration diagnostic and monitoring application 208, 308 (FIG. 1) firmware offer capability to log activity to the system log application 26 (e.g., a Syslog & Windows Event Log) to detect unauthorized changes to the system configuration, and audit user account access, in addition to the access protocol manager 204 (e.g., RADIUS server).

In the illustrated example, the memory 402 includes one or more custom applications 422, which may be applications written by the facility or a third party that takes advantage of the group permissions 412.

In some examples, the firmware of the field device is configured by the manufacturer according to the active directory architecture disclosed herein. In other examples, older or legacy field devices can be updated (e.g., by an admin) to use the active directory architecture disclosed herein.

Any of the blocks in the memory 402 may be instantiated (e.g., creating an instance of, bring into being for any length of time, materialize, implement, etc.) by the programmable circuitry 400 executing the instructions. Additionally or alternatively, any of the blocks in the memory 402 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

While an example manner of implementing the user management system 110 of FIG. 1 is illustrated in FIG. 2, one or more of the elements, processes, and/or devices illustrated in FIG. 2 may be combined, divided, re-arranged, omitted, eliminated, and/or implemented in any other way. Further, the active directory server 200, the CDMA 208, the system log application 214, the IAM tools and other tools 216, and/or, more generally, the example user management system 110 of FIG. 2, may be implemented by hardware alone or by hardware in combination with software and/or firmware. Thus, for example, any of the active directory server 200, the CDMA 208, the system log application 214, the IAM tools and other tools 216, and/or, more generally, the example user management system 110, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Similarly, one or more of the elements, processes, and/or devices of the computer 106 illustrated in FIG. 3 may be combined, divided, re-arranged, omitted, eliminated, and/or implemented in any other way. The device list 310, the update keys 312, the configuration manager 314, the custom applications tool kit 316, the diagnostic and monitoring tools 318, the event log 320, and/or, more generally, CDMA 308 of FIG. 3, may be implemented by hardware alone or by hardware in combination with software and/or firmware. Thus, for example, any of the device list 310, the update keys 312, the configuration manager 314, the custom applications tool kit 316, the diagnostic and monitoring tools 318, the event log 320, and/or, more generally, the example user management system 110, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Similarly, one or more of the elements, processes, and/or devices of the field device 102 illustrated in FIG. 4 may be combined, divided, re-arranged, omitted, eliminated, and/or implemented in any other way. The group permissions 412, the update key 414, the session keys 416, the limited use password 418, the event log 420, and/or the custom applications 422 may be implemented by hardware alone or by hardware in combination with software and/or firmware. Thus, for example, any of group permissions 412, the update key 414, the session keys 416, the limited use password 418, the event log 420, and/or the custom applications 422 could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example user management system 110, the computer 106, and/or the field device 102 may include one or more elements, processes, and/or devices in addition to, or instead of, those illustrated in FIGS. 2-4, and/or may include more than one of any or all of the illustrated elements, processes and devices.

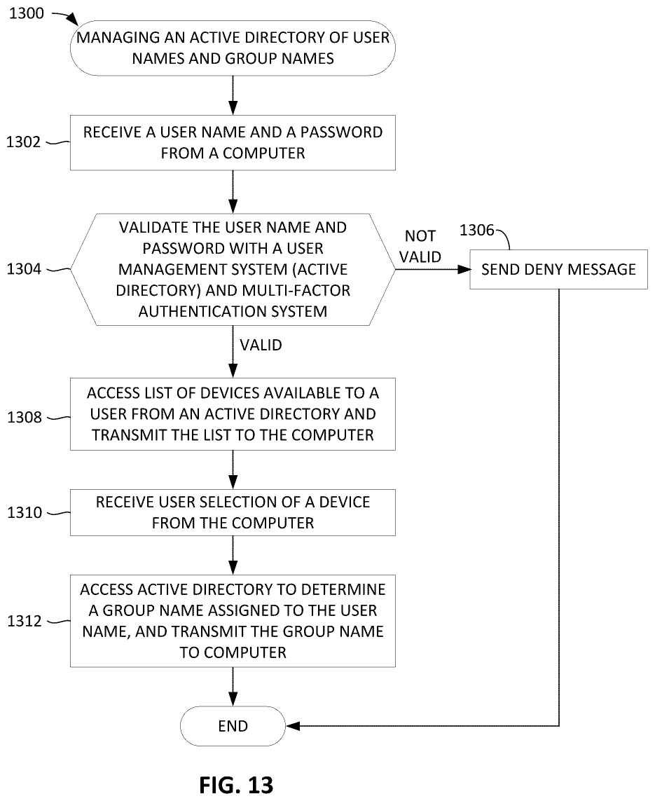

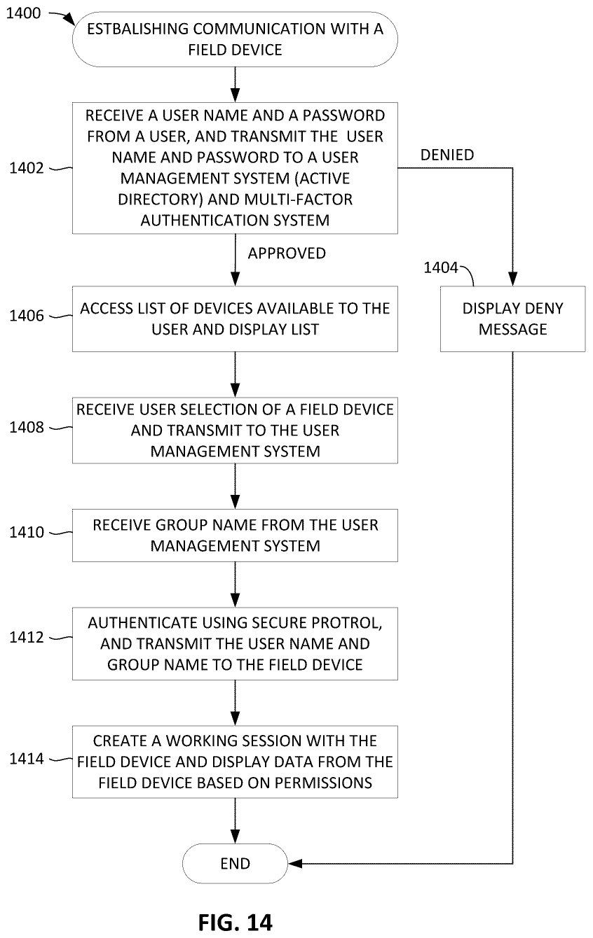

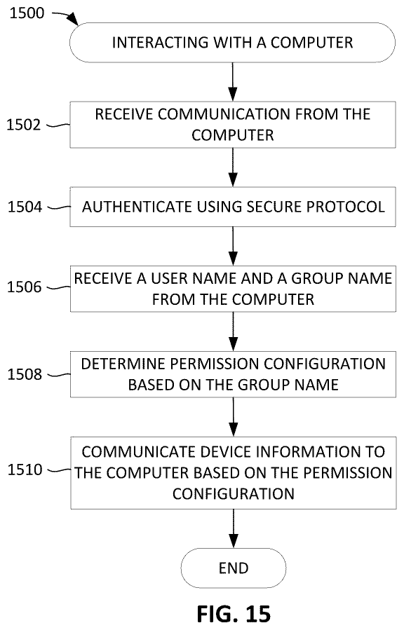

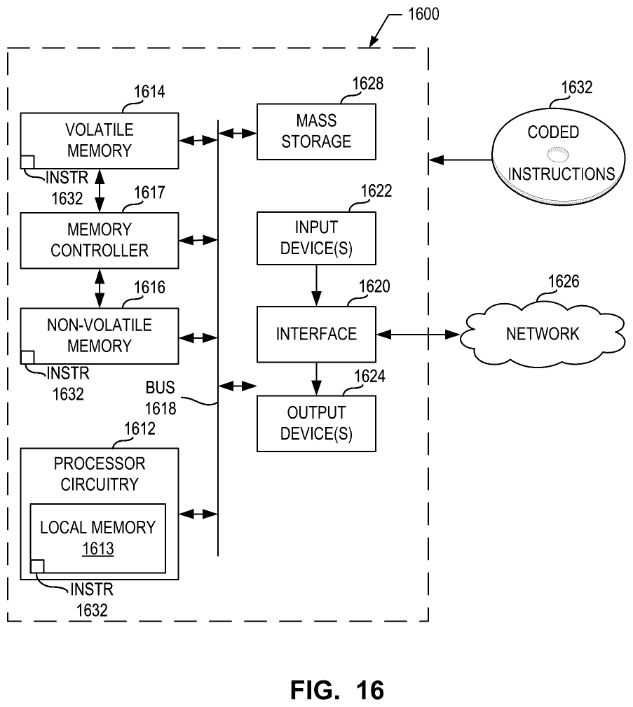

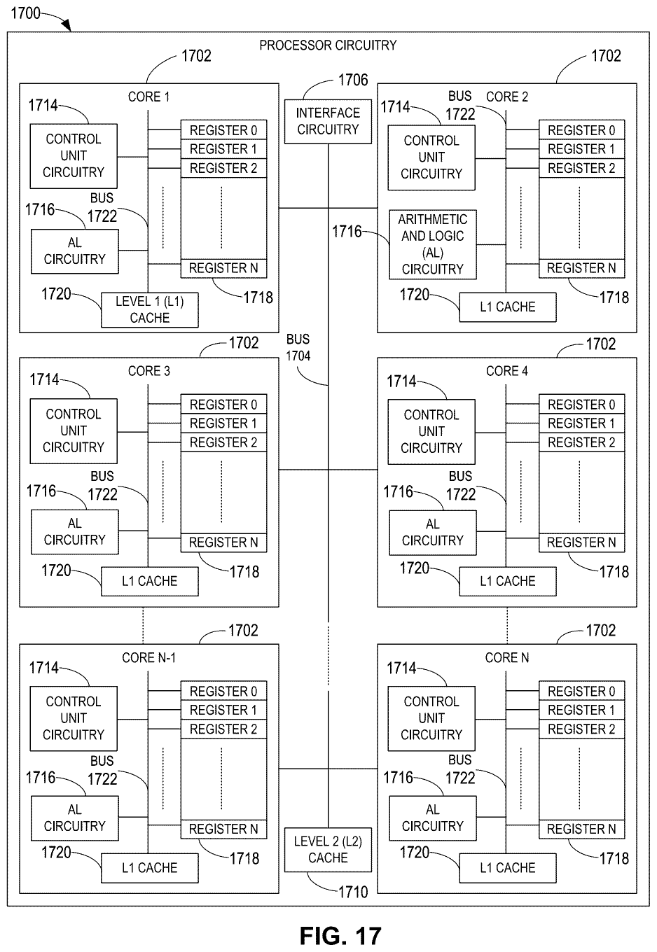

A flowchart representative of example machine readable instructions, which may be executed by programmable circuitry to implement and/or instantiate the user management system 110 of FIG. 2 and/or representative of example operations which may be performed by programmable circuitry to implement and/or instantiate the user management system 110 of FIG. 1, is shown in FIG. 13. A flowchart representative of example machine readable instructions, which may be executed by programmable circuitry to implement and/or instantiate the computer 106 of FIG. 3 and/or representative of example operations which may be performed by programmable circuitry to implement and/or instantiate the computer 106 of FIG. 3, is shown in FIG. 14. A flowchart representative of example machine readable instructions, which may be executed by programmable circuitry to implement and/or instantiate the field device 102 of FIG. 4 and/or representative of example operations which may be performed by programmable circuitry to implement and/or instantiate the field device 102 of FIG. 4, is shown in FIG. 15. The machine readable instructions may be one or more executable programs or portion(s) of one or more executable programs for execution by programmable circuitry such as the programmable circuitry 1612 shown in the example processor platform 1600 discussed below in connection with FIG. 16 and/or may be one or more function(s) or portion(s) of functions to be performed by the example programmable circuitry (e.g., an FPGA) discussed below in connection with FIGS. 17 and/or 18. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 13-15, many other methods of implementing the example user management system 110, the computer 106, and/or the field device 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 13-15 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 13 is a flowchart representative of example machine readable instructions and/or example operations 1300 that may be executed, instantiated, and/or performed by programmable circuitry to implement the user management system 110 for managing an active directory of user names and group names. The example machine-readable instructions and/or the example operations 1300 of FIG. 13 begin at block 1302, at which the user management system 110 receives (e.g., via the communication circuitry 218) user credentials, including a user name and a password, from the computer 106. For example, if the user 104 desires to connect to a field device, the user 104 enters their user name and password into the CDMA 308 on the computer 106 (e.g., using the window 1000 of FIG. 10) and the computer 106 transmits the user name and the password to the user management system 110. In some examples, the CDMA 308 at the computer 106 and CDMA 208 at the user management system 110 use certificates to communicate encrypted data securely. The credential manager 210 can be used to distribute and update these certificates.

At block 1304, the access protocol manager 204 of the active directory server 200 validates the user name and password. For example, the access protocol manager 204 compares the user name and the password to an active list of user names and passwords. In some examples, the access protocol manager 204 validates or authenticates the user name and password using LDAP/LDAPS (and/or Radius/DUO). In some examples, a multi-factor authentication system (e.g., the system 112) can be used to further validate the user 104. If the user name and/or the password are not valid (e.g., do not match an active user name and password) or does not pass the multi-factor authentication check, the user management system 110 returns a deny message, at block 1306. In some examples, failed login attempts are recorded in the system log application 214. If the user name and password are valid (and, in some examples, the user 104 passes the multi-factor authentication check), at block 1308, the CDMA 308 accesses the list of field device available to the user 104 and transmits (e.g., via the communication circuitry 218) the list of field devices to the computer 106. In some examples, a master list of the devices available to the user 104 is stored in the credential manager 210, and a copy of the list of devices is also stored in the CMDA 308 on the computer 206. Once the computer 206 is connected to and logged into the CDMA 208 at the user management system 100, the list on the computer 106 is updated by the master list in the credential manager 210. The credential manager 210 may also communicate with the active directory server 200 to verify which devices the user has access to in the active directory 202 and updates the master list. Additionally or alternatively, the device list could be prepared at runtime and the visibility of the devices is based on the logged in user group name, and all the devices that contain the user group name are displayed to the user 104. At the computer 106, the user 104 may select one of the devices (e.g., from the device list 310) to connect to. For example, the user 104 may view the field devices in the window 1100 of FIG. 11 and select one of the available field devices.

At block 1310, the user management system 110 receives, from the computer 106, a user selection of one of the devices from the list of devices. At block 1312, the active directory server 200 accesses the active directory 202 to determine and/or otherwise obtain the group assigned to the user name. As disclosed above, the active directory 202 can be configured in different manners. In some examples, each user name is assigned to a certain group name (e.g., Engineer, Measurement Tech, Auditor, Operator) for all devices. In other examples, each user name can be assigned to a different group name for each of a plurality of field devices, as shown in FIG. 6. In such an instance, the active directory server 200 accesses the active directory 202 to determine the group name assigned to the user name for the selected one of the devices. Additionally or alternatively, each user name can be assigned to a different group name for each of a plurality of locations, as shown in FIG. 7. The user management system 110 transmits (e.g., via the communication circuitry 218) the group name to the computer 106. The group name is used to enable the field device 102 to determine a permission configuration associated with the group name. After sending the group name to the computer 106, the user management system 110 waits for another request from the same computer or another computer and the example process 1300 is repeated.

FIG. 14 is a flowchart representative of example machine readable instructions and/or example operations 1400 that may be executed, instantiated, and/or performed by programmable circuitry to implement the computer 106 for establishing communication with a field device. The example machine-readable instructions and/or the example operations 1400 of FIG. 14 begin at block 1402, at which the CDMA 308 receives the user name and password. For example, as shown in FIG. 10, the CDMA 308 causes the window 1000 to be displayed, and the user 104 enters their user name and password. The computer 106 transmits (e.g., via the communication circuitry 304) the user name and password to the user management system 110. The active directory server 200 at the user management system 110 validates the user name and password to ensure they are valid. In some examples, the user 104 is further validated using a multi-factor authentication system. If the user credentials are not valid (e.g., the user does not have an active account, the user typed in the wrong user name and/or password, etc.) and/or the user 104 does not pass the multi-factor authentication check, the communication circuitry 304 receives a deny message from the user management system 110 and the CDMA 308 displays (e.g., via the user interface 302) the deny message to the user 104, at block 1404. Assuming the user 104 has a valid user name and password (and, in some examples, passes the multi-factor authentication check), at block 1406, the computer 106 accesses the list of devices and CDMA 308 displays (e.g., on the user interface 302) the list of devices to the user 104. For example, FIG. 11 shows an example window 1100 displaying the device list 310. As disclosed above, in some examples, a copy of the list of devices available to the user 104 is stored on the computer 106, and a master copy of the list of devices is stored in the credential manager 210 at the CDMA 208. Once the user 104 has logged in to the CDMA 208, 308, the credential manager 210 pushes the master list or any updated changes to the copy stored on the computer 106. Therefore, in some examples, the computer 106 receives the list or changes to the list from the user management system 110.

At block 1408, the CDMA 308 receives a user selection of one of the devices from the device list 310 to which the user 104 desires to connect. The computer 106 transmits (e.g., via the communication circuitry 304) the selected device name to the user management system 110.

The active directory server 200 accesses the active directory 202 to determine the group name assigned to the user name (e.g., which may be specific to a device) and transmits the group name to the computer 106. At block 1410, the computer 106 receives (e.g., via the communication circuitry 304) the group name assigned to the user name from the user management system 110. In some examples, a user may be assigned to two or more groups for a specific device. In that instance, if two or more group names are returned, the CDMA 308 may display a window with the group options (e.g., Engineer or Auditor) and allow the user 104 to select the desired group name.

At block 1412, the CDMA 308 authenticates and establishes a secure connection with the field device 102 using a secure protocol, such as DNP3 with SAV5. For example, when the user 104 selects the field device (block 1408), the computer 106 transmits a message to establish a secure connection with the selected field device using the update key 312 for that field device. Thereafter, messages are transmitted back-and-forth between the computer 106 and the field device using session keys 416 (FIG. 4), for example. The computer 106 can be connected to the field device via a physical communication connection such as Ethernet, USB, etc. or via a wireless communication connection such as cellular, Bluethooth®, etc. At block 1412, the computer 106 transmits the user name and the group name to the field device 102. The field device 102 determines the permission configuration based on the group name (e.g., see FIG. 12). At block 1414, the computer 106 creates or establishes a working session (e.g., using the session keys) with the field device 102 to display data from the field device 102 based on the permission configuration in the field device 102 associated with the group name. The user can use the CDMA 308 on the computer 106 to view the field device data and interact with the field device 102 based on the permissions authorized by the field device 102. For example, the user 104 may be able to view certain sensor measurements, configurations, etc. In some examples, based on the permissions, the user 104 may be able to perform certain operations such as update firmware, change a configuration of the field device, etc. In some examples, the user name is sent to the field device 102 along with the group name so that the field device 102 can store the user name in the event log 420 to track any changes made by the user 104. That way, if there is a discrepancy or issue in the future, the issue can be tracked back to a specific user. When the user 104 desires to end the session, the user 104 can log out of the CDMA 308 and/or otherwise disconnect from the field device 102.

FIG. 15 is a flowchart representative of example machine readable instructions and/or example operations 1500 that may be executed, instantiated, and/or performed by programmable circuitry to implement the field device 102 for interacting with the computer 106. The example machine-readable instructions and/or the example operations 1500 of FIG. 15 begin at block 1502, at which the field device 102 receives (e.g., via the communication circuitry 404) a communication (e.g., message) from the computer 106. As disclosed above, the computer 106 and the field device 102 can be connected via any wired or wireless type of connection. At block 1504, the field device 102 authenticates the computer 106 using a secure protocol. In particular, the field device 102 uses the update key 414 to authenticate the computer 106 and create sessions keys 416 for the rest of the working session thereafter.

At block 1506, the field device 102 receives (e.g., via the communication circuitry 404) a user name and a group name from the computer 106. At block 1508, the programmable circuity 400 accesses the group permissions 412 to determine a permission configuration based on the group name. The group permissions 412 can include different permission configurations for each of the group names. For example, as shown in FIG. 12, each group name may have a different set or configuration of permissions. The field device 102 establishes a working session with the computer 106 to allow access and communications between the field device 102 and the computer 106. At block 1510, the field device 102 communicates device information to the computer 106 based on the permission configuration. As disclosed above, depending on the group, some users may only be able to view certain information and/or make certain changes to the field device 102. In some examples, during the working session, the programmable circuitry 400 logs all changes to data in the event log 420 under the user name. When the user 104 desires to end the session, the user 104 logs out and/or disconnects from the field device 102 and the connection is ended. This example process 1500 can occur at each field device 102a-102n each time a user connects to the field device.

As disclosed above, in some instances, the computer 106 may not have a connection to the user management system 110 and therefore cannot obtain the group name from the active directory server 200. In such an instance, the user 104 can still connect to the field device 102 using the limited use password (e.g., a one-time user password). In this scenario, the user 104 can call and/or otherwise obtain the limited use password from their admin or IT department for the field device 102. The admin or IT department can obtain the limited use password from the limited use password manager 212, such as by using the window 900 of FIG. 9. The user 104 enters their user name and the limited use password into the CDMA 308 on the computer 106 (e.g., see FIG. 10). The computer 106 transmits the limited use password to the field device 102. The field device 102 checks the limited use password against the limited use password 418 saved in the memory 402. If the limited use password sent by the computer 106 is valid, a working session is established between the field device 102 and the computer 106. In some examples, when the limited use password 418 is used, there are no group permissions and the user 418 has full admin access to all data and permissions on the field device 102. However, in other examples, the limited use password manager 212 can create limited use passwords for each group name for each device, which are also stored on the field device. Therefore, if the user is an Engineer, for example, the admin/IT person would give them the limited use password for an Engineer. Therefore, when the field device 102 receives a limited use password for an Engineer, the field device 102 can provide permissions or privileges based on the Engineer group.

FIG. 16 is a block diagram of an example programmable circuitry platform 1600 structured to execute and/or instantiate the example machine-readable instructions and/or the example operations of FIGS. 13-15. In particular, the programmable circuitry platform 1600 can be used to implement any of the user management system 110, the computer 106, or the field device 102. The programmable circuitry platform 1600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a wearable device, or any other type of computing and/or electronic device.

The programmable circuitry platform 1600 of the illustrated example includes programmable circuitry 1612. The programmable circuitry 1612 of the illustrated example is hardware. For example, the programmable circuitry 1612 can be implemented by one or more integrated circuits, logic circuits, FPGAs, microprocessors, CPUs, GPUs, DSPs, and/or microcontrollers from any desired family or manufacturer. The programmable circuitry 1612 may be implemented by one or more semiconductor based (e.g., silicon based) devices.

The programmable circuitry 1612 of the illustrated example includes a local memory 1613 (e.g., a cache, registers, etc.). The programmable circuitry 1612 of the illustrated example is in communication with main memory 1614, 1616, which includes a volatile memory 1614 and a non-volatile memory 1616, by a bus 1618. The volatile memory 1614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1616 may be implemented by flash memory and/or any other desired type of memory device. Access to the main memory 1614, 1616 of the illustrated example is controlled by a memory controller 1617. In some examples, the memory controller 1617 may be implemented by one or more integrated circuits, logic circuits, microcontrollers from any desired family or manufacturer, or any other type of circuitry to manage the flow of data going to and from the main memory 1614, 1616.

The programmable circuitry platform 1600 of the illustrated example also includes interface circuitry 1620. The interface circuitry 1620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1622 are connected to the interface circuitry 1620. The input device(s) 1622 permit(s) a user (e.g., a human user, a machine user, etc.) to enter data and/or commands into the programmable circuitry 1612. The input device(s) 1622 can be implemented by, for example, a measurement sensor (e.g., a temperature sensor, a pressure sensor, a flow rate sensor, etc.), an audio sensor, a microphone, a camera (still or video), a keyboard, a button, a mouse, a touchscreen, a trackpad, a trackball, an isopoint device, and/or a voice recognition system.

One or more output devices 1624 are also connected to the interface circuitry 1620 of the illustrated example. The output device(s) 1624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a motor or actuator, a tactile output device, a printer, and/or speaker. The interface circuitry 1620 of the illustrated example, thus, typically includes a graphics driver card, a graphics driver chip, and/or graphics processor circuitry such as a GPU.

The interface circuitry 1620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1600 of the illustrated example also includes one or more mass storage discs or devices 1628 to store firmware, software, and/or data. Examples of such mass storage discs or devices 1628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1632, which may be implemented by the machine readable instructions of FIGS. 13-15, may be stored in the mass storage device 1628, in the volatile memory 1614, in the non-volatile memory 1616, and/or on at least one non-transitory computer readable storage medium such as a CD or DVD which may be removable.

FIG. 17 is a block diagram of an example implementation of the programmable circuitry 1612 of FIG. 16. In this example, the programmable circuitry 1612 of FIG. 16 is implemented by a microprocessor 1700. For example, the microprocessor 1700 may be a general-purpose microprocessor (e.g., general-purpose microprocessor circuitry). The microprocessor 1700 executes some or all of the machine-readable instructions of the flowcharts of FIGS. 13-15 to effectively instantiate the circuitry of FIGS. 2-4 as logic circuits to perform operations corresponding to those machine readable instructions. In some such examples, the circuitry of FIGS. 2-4 is instantiated by the hardware circuits of the microprocessor 1700 in combination with the machine-readable instructions. For example, the microprocessor 1700 may be implemented by multi-core hardware circuitry such as a CPU, a DSP, a GPU, an XPU, etc. Although it may include any number of example cores 1702 (e.g., 1 core), the microprocessor 1700 of this example is a multi-core semiconductor device including N cores. The cores 1702 of the microprocessor 1700 may operate independently or may cooperate to execute machine readable instructions. For example, machine code corresponding to a firmware program, an embedded software program, or a software program may be executed by one of the cores 1702 or may be executed by multiple ones of the cores 1702 at the same or different times. In some examples, the machine code corresponding to the firmware program, the embedded software program, or the software program is split into threads and executed in parallel by two or more of the cores 1702. The software program may correspond to a portion or all of the machine readable instructions and/or operations represented by the flowcharts of FIGS. 13-15.

The cores 1702 may communicate by a first example bus 1704. In some examples, the first bus 1704 may be implemented by a communication bus to effectuate communication associated with one(s) of the cores 1702. For example, the first bus 1704 may be implemented by at least one of an Inter-Integrated Circuit (I2C) bus, a Serial Peripheral Interface (SPI) bus, a PCI bus, or a PCIe bus. Additionally or alternatively, the first bus 1704 may be implemented by any other type of computing or electrical bus. The cores 1702 may obtain data, instructions, and/or signals from one or more external devices by example interface circuitry 1706. The cores 1702 may output data, instructions, and/or signals to the one or more external devices by the interface circuitry 1706. Although the cores 1702 of this example include example local memory 1720 (e.g., Level 1(L1) cache that may be split into an L1 data cache and an L1 instruction cache), the microprocessor 1700 also includes example shared memory 1710 that may be shared by the cores (e.g., Level 2 (L2 cache)) for high-speed access to data and/or instructions. Data and/or instructions may be transferred (e.g., shared) by writing to and/or reading from the shared memory 1710. The local memory 1720 of each of the cores 1702 and the shared memory 1710 may be part of a hierarchy of storage devices including multiple levels of cache memory and the main memory (e.g., the main memory 1614, 1616 of FIG. 16). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1702 may be referred to as a CPU, DSP, GPU, etc., or any other type of hardware circuitry. Each core 1702 includes control unit circuitry 1714, arithmetic and logic (AL) circuitry (sometimes referred to as an ALU) 1716, a plurality of registers 1718, the local memory 1720, and a second example bus 1722. Other structures may be present. For example, each core 1702 may include vector unit circuitry, single instruction multiple data (SIMD) unit circuitry, load/store unit (LSU) circuitry, branch/jump unit circuitry, floating-point unit (FPU) circuitry, etc. The control unit circuitry 1714 includes semiconductor-based circuits structured to control (e.g., coordinate) data movement within the corresponding core 1702. The AL circuitry 1716 includes semiconductor-based circuits structured to perform one or more mathematic and/or logic operations on the data within the corresponding core 1702. The AL circuitry 1716 of some examples performs integer based operations. In other examples, the AL circuitry 1716 also performs floating-point operations. In yet other examples, the AL circuitry 1716 may include first AL circuitry that performs integer-based operations and second AL circuitry that performs floating-point operations. In some examples, the AL circuitry 1716 may be referred to as an Arithmetic Logic Unit (ALU).

The registers 1718 are semiconductor-based structures to store data and/or instructions such as results of one or more of the operations performed by the AL circuitry 1716 of the corresponding core 1702. For example, the registers 1718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1718 may be arranged in a bank as shown in FIG. 17. Alternatively, the registers 1718 may be organized in any other arrangement, format, or structure, such as by being distributed throughout the core 1702 to shorten access time. The second bus 1722 may be implemented by at least one of an I2C bus, a SPI bus, a PCI bus, or a PCIe bus.

Each core 1702 and/or, more generally, the microprocessor 1700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1700 is a semiconductor device fabricated to include many transistors interconnected to implement the structures described above in one or more integrated circuits (ICs) contained in one or more packages.

The microprocessor 1700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1700, in the same chip package as the microprocessor 1700 and/or in one or more separate packages from the microprocessor 1700.

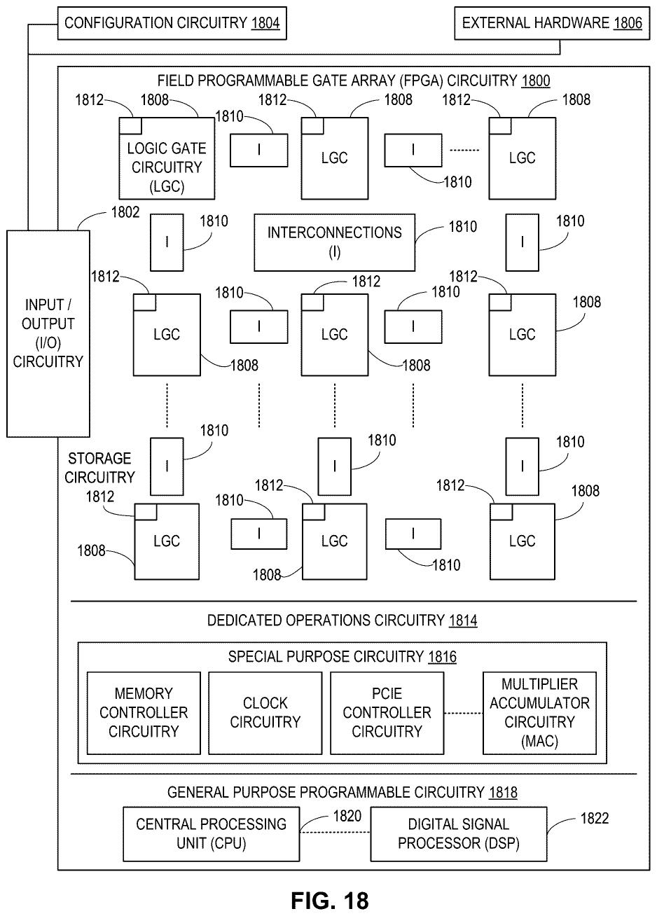

FIG. 18 is a block diagram of another example implementation of the programmable circuitry 1612 of FIG. 16. In this example, the programmable circuitry 1612 is implemented by FPGA circuitry 1800. For example, the FPGA circuitry 1800 may be implemented by an FPGA. The FPGA circuitry 1800 can be used, for example, to perform operations that could otherwise be performed by the example microprocessor 1700 of FIG. 17 executing corresponding machine readable instructions. However, once configured, the FPGA circuitry 1800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1700 of FIG. 17 described above (which is a general purpose device that may be programmed to execute some or all of the machine readable instructions represented by the flowchart(s) of FIGS. 13-15 but whose interconnections and logic circuitry are fixed once fabricated), the FPGA circuitry 1800 of the example of FIG. 18 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 13-15. In particular, the FPGA circuitry 1800 may be thought of as an array of logic gates, interconnections, and switches. The switches can be programmed to change how the logic gates are interconnected by the interconnections, effectively forming one or more dedicated logic circuits (unless and until the FPGA circuitry 1800 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 13-15. As such, the FPGA circuitry 1800 may be configured and/or structured to effectively instantiate some or all of the operations/functions corresponding to the machine readable instructions of the flowchart(s) of FIGS. 13-15 as dedicated logic circuits to perform the operations/functions corresponding to those software instructions in a dedicated manner analogous to an ASIC. Therefore, the FPGA circuitry 1800 may perform the operations/functions corresponding to the some or all of the machine readable instructions of FIGS. 13-15 faster than the general-purpose microprocessor can execute the same.

In the example of FIG. 18, the FPGA circuitry 1800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1800 of FIG. 18 may access and/or load the binary file to cause the FPGA circuitry 1800 of FIG. 18 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1800 of FIG. 18 to cause configuration and/or structuring of the FPGA circuitry 1800 of FIG. 18, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1800 of FIG. 18 may access and/or load the binary file to cause the FPGA circuitry 1800 of FIG. 18 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1800 of FIG. 18 to cause configuration and/or structuring of the FPGA circuitry 1800 of FIG. 18, or portion(s) thereof.

The FPGA circuitry 1800 of FIG. 18, includes example input/output (I/O) circuitry 1802 to obtain and/or output data to/from example configuration circuitry 1804 and/or external hardware 1806. For example, the configuration circuitry 1804 may be implemented by interface circuitry that may obtain a binary file, which may be implemented by a bit stream, data, and/or machine-readable instructions, to configure the FPGA circuitry 1800, or portion(s) thereof. In some such examples, the configuration circuitry 1804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1806 may be implemented by external hardware circuitry. For example, the external hardware 1806 may be implemented by the microprocessor 1700 of FIG. 17.

The FPGA circuitry 1800 also includes an array of example logic gate circuitry 1808, a plurality of example configurable interconnections 1810, and example storage circuitry 1812. The logic gate circuitry 1808 and the configurable interconnections 1810 are configurable to instantiate one or more operations/functions that may correspond to at least some of the machine readable instructions of FIGS. 13-15 and/or other desired operations. The logic gate circuitry 1808 shown in FIG. 18 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1808 to enable configuration of the electrical structures and/or the logic gates to form circuits to perform desired operations/functions. The logic gate circuitry 1808 may include other electrical structures such as look-up tables (LUTs), registers (e.g., flip-flops or latches), multiplexers, etc.

The configurable interconnections 1810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1808 to program desired logic circuits.

The storage circuitry 1812 of the illustrated example is structured to store result(s) of the one or more of the operations performed by corresponding logic gates. The storage circuitry 1812 may be implemented by registers or the like. In the illustrated example, the storage circuitry 1812 is distributed amongst the logic gate circuitry 1808 to facilitate access and increase execution speed.

The example FPGA circuitry 1800 of FIG. 18 also includes example dedicated operations circuitry 1814. In this example, the dedicated operations circuitry 1814 includes special purpose circuitry 1816 that may be invoked to implement commonly used functions to avoid the need to program those functions in the field. Examples of such special purpose circuitry 1816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1800 may also include example general purpose programmable circuitry 1818 such as an example CPU 1820 and/or an example DSP 1822. Other general purpose programmable circuitry 1818 may additionally or alternatively be present such as a GPU, an XPU, etc., that can be programmed to perform other operations.

Although FIGS. 17 and 18 illustrate two example implementations of the programmable circuitry 1612 of FIG. 16, many other approaches are contemplated. For example, FPGA circuitry may include an on-board CPU, such as one or more of the example CPU 1820 of FIG. 17. Therefore, the programmable circuitry 1612 of FIG. 16 may additionally be implemented by combining at least the example microprocessor 1700 of FIG. 17 and the example FPGA circuitry 1800 of FIG. 18. In some such hybrid examples, one or more cores 1702 of FIG. 17 may execute a first portion of the machine readable instructions represented by the flowchart(s) of FIGS. 13-15 to perform first operation(s)/function(s), the FPGA circuitry 1800 of FIG. 18 may be configured and/or structured to perform second operation(s)/function(s) corresponding to a second portion of the machine readable instructions represented by the flowcharts of FIG. 13-15, and/or an ASIC may be configured and/or structured to perform third operation(s)/function(s) corresponding to a third portion of the machine readable instructions represented by the flowcharts of FIGS. 13-15.

It should be understood that some or all of the circuitry of FIGS. 2-4 may, thus, be instantiated at the same or different times. For example, same and/or different portion(s) of the microprocessor 1700 of FIG. 17 may be programmed to execute portion(s) of machine-readable instructions at the same and/or different times. In some examples, same and/or different portion(s) of the FPGA circuitry 1800 of FIG. 18 may be configured and/or structured to perform operations/functions corresponding to portion(s) of machine-readable instructions at the same and/or different times.

In some examples, some or all of the circuitry of FIGS. 2-4 may be instantiated, for example, in one or more threads executing concurrently and/or in series. For example, the microprocessor 1700 of FIG. 17 may execute machine readable instructions in one or more threads executing concurrently and/or in series. In some examples, the FPGA circuitry 1800 of FIG. 18 may be configured and/or structured to carry out operations/functions concurrently and/or in series. Moreover, in some examples, some or all of the circuitry of FIGS. 2-4 may be implemented within one or more virtual machines and/or containers executing on the microprocessor 1700 of FIG. 17.

In some examples, the programmable circuitry 1612 of FIG. 16 may be in one or more packages. For example, the microprocessor 1700 of FIG. 17 and/or the FPGA circuitry 1800 of FIG. 18 may be in one or more packages. In some examples, an XPU may be implemented by the programmable circuitry 1612 of FIG. 16, which may be in one or more packages. For example, the XPU may include a CPU (e.g., the microprocessor 1700 of FIG. 17, the CPU 1820 of FIG. 18, etc.) in one package, a DSP (e.g., the DSP 1822 of FIG. 18) in another package, a GPU in yet another package, and an FPGA (e.g., the FPGA circuitry 1800 of FIG. 18) in still yet another package.

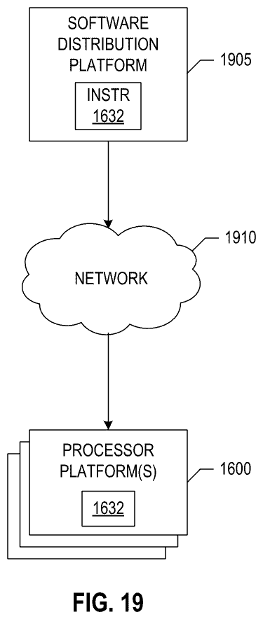

A block diagram illustrating an example software distribution platform 1905 to distribute software such as the example machine readable instructions 1632 of FIG. 16 to other hardware devices (e.g., hardware devices owned and/or operated by third parties from the owner and/or operator of the software distribution platform) is illustrated in FIG. 19. For example, the software distribution platform 1905 can be used to distribute software to the user management system 110, the computer 106, and/or the field device 102 corresponding to the instructions of FIGS. 13-15, respectively. The example software distribution platform 1905 may be implemented by any computer server, data facility, cloud service, etc., capable of storing and transmitting software to other computing devices. The third parties may be customers of the entity owning and/or operating the software distribution platform 1905. For example, the entity that owns and/or operates the software distribution platform 1905 may be a developer, a seller, and/or a licensor of software such as the example machine readable instructions 1632 of FIG. 16. The third parties may be consumers, users, retailers, OEMs, etc., who purchase and/or license the software for use and/or re-sale and/or sub-licensing. In the illustrated example, the software distribution platform 1905 includes one or more servers and one or more storage devices. The storage devices store the machine readable instructions 1632, which may correspond to the example machine readable instructions of FIGS. 13-15, as described above. The one or more servers of the example software distribution platform 1905 are in communication with an example network 1910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1632 from the software distribution platform 1905. For example, the software, which may correspond to the example machine readable instructions of FIG. 13-15, may be downloaded to the example programmable circuitry platform 1600, which is to execute the machine readable instructions 1632 to implement the user management system 110, the computer 106, or the field device 102. In some examples, one or more servers of the software distribution platform 1905 periodically offer, transmit, and/or force updates to the software (e.g., the example machine readable instructions 1632 of FIG. 16) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that use an active directory of user group (e.g., role) names to manage user permissions when accessing a field device. The examples disclosed herein reduce or eliminate the need for storing every user account and its associated permission on each field device. This greatly reduces memory and computing resources required by the field devices. The example systems and methods disclosed herein also utilize security keys, including limited use passwords, managed at a central location.

Examples and combinations of examples disclosed herein include the following:
Example 1 is a process control system comprising: a user management system including an active directory having user names and group names assigned to respective ones of the user names; a computer to communicate with the user management system over a network; and a field device to communicate with the user management system and the computer over the network, wherein the computer is to be operated by a user to connect to and access information on the field device, the user having a first user name, wherein the field device is to: determine a first permission configuration associated with a first group name assigned to the first user name; and establish a working session with the computer and allow access and communications between the field device and the computer based on the first permission configuration.
Example 2 includes the process control system of Example 1, wherein the computer is to: receive the first user name and a first password from the user; transmit the first user name and the first password to the user management system; receive, from the user management system, the first group name assigned to the first user name; and transmit the first group name to the field device.
Example 3 includes the process control system of Examples 1 or 2, wherein the field device has group permissions stored in a memory, the group permissions including the first permission configuration for the first group name.
Example 4 includes the process control system of Example 3, wherein the field device is a first field device, the process control system including a second field device, the second field device including group permissions including a second permission configuration for the first group name that is different than the first permission configuration.
Example 5 includes the process control system of any of Examples 1-4, wherein the active directory has group names assigned to respective ones of the user names for each of a plurality of field devices.
Example 6 includes the process control system of any of Examples 1-5, wherein the active directory has group names assigned to respective ones of the user names for each of a plurality of locations.
Example 7 is a user management system comprising: an active directory having user names and group names assigned to respective ones of the user names; machine readable instructions; and programmable circuitry to at least one of instantiate or execute the machine readable instructions to: validate a user name and a password received from a computer, wherein the computer is operated by a user to connect to a field device; access the active directory to determine a group name assigned to the user name; and transmit the group name to the computer, wherein the group name is to enable the field device to determine a permission configuration associated with the group name.
Example 8 includes the user management system of Example 7, wherein the active directory has group names assigned to respective ones of the user names for each of a plurality of field devices.
Example 9 includes the user management system of Example 8, wherein the programmable circuitry is to: access a list of devices available to the user; transmit the list of devices to the computer; receive, from the computer, a user selection of one of the devices from the list of devices; and access the active directory to determine the group name assigned to the user name for the selected one of the devices.
Example 10 includes the user management system of any of Examples 7-9, wherein the active directory has group names assigned to respective ones of the user names for each of a plurality of locations.
Example 11 is a non-transitory machine readable storage medium comprising instructions to cause programmable circuitry to at least: validate a user name and a password received from a computer, wherein the computer is operated by a user to connect to a field device; and access an active directory to determine a group name assigned to the user name, the active directory having a plurality of user names and group names assigned to respective ones of the user names; and transmit the group name to the computer, wherein the group name is to enable the field device to determine a permission configuration associated with the group name.
Example 12 includes the non-transitory machine readable storage medium of Example 11, wherein the active directory has group names assigned to respective ones of the user names for each of a plurality of field devices.
Example 13 includes the non-transitory machine readable storage medium of Example 12, wherein the instructions are to cause the programmable circuitry to: access a list of devices available to the user; transmit the list of devices to the computer; receive, from the computer, a user selection of one of the devices from the list of devices; and access the active directory to determine the group name assigned to the user name for the selected one of the devices.
Example 14 includes the non-transitory machine readable storage medium of any of Examples 11-13, wherein the active directory has group names assigned to respective ones of the user names for each of a plurality of locations.
Example 15 is a computer including communication circuitry; a user interface; machine readable instructions; and programmable circuitry to at least one of instantiate or execute the machine readable instructions to: transmit a user name and a password of a user to a user management system having an active directory of user names and group names assigned to respective ones of the user names; receive a group name assigned to the user name from the user management system; transmit the group name to a field device; and create a working session with the field device and display data from the field device based on a permission configuration in the field device associated with the group name.
Example 16 includes the computer of Example 15, wherein the programmable circuitry is to: after transmitting the user name and password to the user management system, access a list of devices available to the user; display the list of devices to the user; receive a user selection of one of the devices; and transmit the user selection of the one of the devices to the user management system.
Example 17 includes the computer of Examples 15 or 16, wherein the programmable circuitry is to transmit the user name along with the group name to the field device.
Example 18 is a non-transitory machine readable storage medium comprising instructions to cause programmable circuitry to at least: transmit a user name and a password of a user to a user management system having an active directory of user names and group names assigned to respective ones of the user names; receive a group name assigned to the user name from the user management system; transmit the group name to a field device; and create a working session with the field device and display data from the field device based on a permission configuration in the field device associated with the group name.
Example 19 includes the non-transitory machine readable storage medium of claim 18, wherein the instructions are to cause the programmable circuitry to: after transmitting the user name and password to the user management system, access a list of devices available to the user; display the list of devices to the user; receive a user selection of one of the devices; and transmit the user selection of the one of the devices to the user management system.
Example 20 includes the non-transitory machine readable storage medium of Examples 18 or 19, wherein the instructions are to cause the programmable circuitry to transmit the user name along with the group name to the field device.
Example 21 is a field device comprising: communication circuitry; memory with group permissions; machine readable instructions; and programmable circuitry to at least one of instantiate or execute the machine readable instructions to: receive communication from a computer and authenticate the computer using a secure protocol; receive a user name and a group name from the computer; access the group permissions to determine a permission configuration based on the group name; and communicate with the computer based on the permission configuration.
Example 22 includes the field device of Example 21, wherein the group permissions includes a different permission configuration for each of a plurality of group names.
Example 23 includes the field device of Examples 21 or 22, wherein the secure protocol is Distributed Network Protocol (DNP3) with SAV5.
Example 24 includes the field device of any of Examples 21-23, further including at least one of a sensor or an actuation mechanism.

Example 25 includes the field device of any of Examples 21-24, wherein the memory stores a limited use password that can be used by a user to access the field device.

Example 26 is a non-transitory machine readable storage medium comprising instructions to cause programmable circuitry to at least: receive communication from a computer and authenticate the computer using a secure protocol; receive a user name and a group name from the computer; access group permissions to determine a permission configuration based on the group name; and communicate with the computer based on the permission configuration.
Example 27 includes the non-transitory machine readable storage medium of Example 26, wherein the group permissions includes a different permission configuration for each of a plurality of group names.
Example 28 includes the non-transitory machine readable storage medium of Examples 26 or 27, wherein the secure protocol is Distributed Network Protocol (DNP3) with SAV5.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. A process control system comprising:
a user management system including an active directory having user names and group names assigned to respective ones of the user names;
a computer to communicate with the user management system over a network; and
a field device to communicate with the user management system and the computer over the network, wherein the computer is to be operated by a user to connect to and access information on the field device, the user having a first user name, wherein the field device is to:
determine a first permission configuration associated with a first group name assigned to the first user name; and
establish a working session with the computer and allow access and communications between the field device and the computer based on the first permission configuration.

2. The process control system of claim 1, wherein the computer is to:
receive the first user name and a first password from the user;
transmit the first user name and the first password to the user management system;
receive, from the user management system, the first group name assigned to the first user name; and
transmit the first group name to the field device.

3. The process control system of claim 1, wherein the field device has group permissions stored in a memory, the group permissions including the first permission configuration for the first group name.

4. The process control system of claim 3, wherein the field device is a first field device, the process control system including a second field device, the second field device including group permissions including a second permission configuration for the first group name that is different than the first permission configuration.

5. The process control system of claim 1, wherein the active directory has group names assigned to respective ones of the user names for each of a plurality of field devices.

6. The process control system of claim 1, wherein the active directory has group names assigned to respective ones of the user names for each of a plurality of locations.

7. A user management system comprising:
an active directory having user names and group names assigned to respective ones of the user names;
machine readable instructions; and
programmable circuitry to at least one of instantiate or execute the machine readable instructions to:
validate a user name and a password received from a computer, wherein the computer is operated by a user to connect to a field device;
access the active directory to determine a group name assigned to the user name; and
transmit the group name to the computer, wherein the group name is to enable the field device to determine a permission configuration associated with the group name.

8. The user management system of claim 7, wherein the active directory has group names assigned to respective ones of the user names for each of a plurality of field devices.

9. The user management system of claim 8, wherein the programmable circuitry is to:
access a list of devices available to the user;
transmit the list of devices to the computer;
receive, from the computer, a user selection of one of the devices from the list of devices; and
access the active directory to determine the group name assigned to the user name for the selected one of the devices.

10. The user management system of claim 7, wherein the active directory has group names assigned to respective ones of the user names for each of a plurality of locations.

11. A non-transitory machine readable storage medium comprising instructions to cause programmable circuitry to at least:
validate a user name and a password received from a computer, wherein the computer is operated by a user to connect to a field device;
access an active directory to determine a group name assigned to the user name, the active directory having a plurality of user names and group names assigned to respective ones of the user names; and
transmit the group name to the computer, wherein the group name is to enable the field device to determine a permission configuration associated with the group name.

12. The non-transitory machine readable storage medium of claim 11, wherein the active directory has group names assigned to respective ones of the user names for each of a plurality of field devices.

13. The non-transitory machine readable storage medium of claim 12, wherein the instructions are to cause the programmable circuitry to:
access a list of devices available to the user;
transmit the list of devices to the computer;
receive, from the computer, a user selection of one of the devices from the list of devices; and
access the active directory to determine the group name assigned to the user name for the selected one of the devices.

14. The non-transitory machine readable storage medium of claim 11, wherein the active directory has group names assigned to respective ones of the user names for each of a plurality of locations.

15-28. (canceled)
